(19) United States
(12) Patent Application Publication
(10) Pub. No.: US 2023/0211520 A1
(43) Pub. Date: Jul. 6, 2023

(54) RECONSTITUTED BAMBOO BOARD INTEGRATING EMBOSSED TEXTURE DECORATION AND PROTECTIVE FUNCTIONS

(71) Applicant: HUNAN TAOHUAJIANG BAMBOO SCIENCE & TECHNOLOGY CO., LTD., Hunan (CN)

(72) Inventors: Jian PENG, Hunan (CN); Ting LI, Hunan (CN); Jie YANG, Hunan (CN); Zhen YANG, Hunan (CN); Zhicheng XUE, Hunan (CN)

(73) Assignee: HUNAN TAOHUAJIANG BAMBOO SCIENCE & TECHNOLOGY CO., LTD., Hunan (CN)

(21) Appl. No.: 18/016,686

(22) PCT Filed: Apr. 22, 2022
(86) PCT No.: PCT/CN2022/088382

§ 371 Date: Jan. 18, 2023

(30) Foreign Application Priority Data
Apr. 29, 2021 (CN) 202120924531.5

(51) Int. Cl. B27N 3/20; B27N 7/00

(52) U.S. Cl. CPC B27N 3/203; B27N 7/005; B27J 1/006

(57) ABSTRACT

The present invention discloses a reconstituted bamboo board integrating an embossed texture decoration and protective functions, comprising a reconstituted bamboo layer and a heat-pressed and cured film layer with an embossed texture decoration located on a surface of the reconstituted bamboo layer.

### CROSS-REFERENCE TO RELATED APPLICATION

This application is a 371 of international application of PCT application serial no. PCT/CN2022/088382, filed on Apr. 22, 2022, which claims the priority benefit of China application no. 202120924531.5 filed on Apr. 29, 2021. The entirety of each of the above-mentioned patent applications is hereby incorporated by reference herein and made a part of this specification.

### BACKGROUND

### Technical Field

This application relates to the technical field of artificial boards, and in particular to a reconstituted bamboo board integrating an embossed texture decoration and protective functions.

### Description of Related Art

In recent years, the supply of high-quality wood, especially hardwood, has become less and less, and the price has become higher and higher. For the reasons of safety and environmental protection, people's demand for wood products is increasing. The aggravation of the contradiction between the supply and demand of wood has seriously restricted the development of wood product decoration and finishing industry of China.

Reconstituted bamboo is a new bamboo material that is formed by reorganizing and strengthening bamboo. First, the bamboo is processed into long strips or bamboo threads or crushed into bamboo strands, and then dried and dipped into glue, and further dried to a required moisture content, and the bamboo strips or threads or strands are then laid in a lay-up mold and heat-pressed and cured under high temperature and high pressure. The reconstituted bamboo has excellent mechanical properties and partial anti-corrosion and mildew-proof properties. Its strength greatly exceeds other wood-based panels and ordinary bamboo-based panels. It has been widely used in flooring, interior decoration and finishing, architecture, garden landscape, and other industries.

However, the current reconstituted bamboo products have a common problem of simple texture structure, and unlike wood, they do not have diverse texture structures, which affects the further promotion and application of reconstituted bamboo products in an all-round way. The existing reconstituted bamboo texture processing technology generally obtains the desired texture by subsequent cutting and scoring, texture paint spraying or engraving with CNC machine tools. These methods require a large amount of material for complex processing, and the material cost is high, and because of the cumbersome cutting and engraving processes, the labor and equipment costs are greatly increased, and the processing efficiency is also reduced. In addition, when reconstituted bamboo products are used outdoors, they need to be protected with paint for surface finishing. However, it is difficult for the paint to penetrate into the reconstituted bamboo, and it is easy for the paint to fall off and fade during use because the reconstituted bamboo has a high density.

### SUMMARY

The technical problem to be solved by this application is to overcome the deficiencies of the prior art, and to provide a reconstituted bamboo board with an effect of texture decoration, a function of weather-resistant protection, simple process, high processing efficiency and low cost.

In order to solve the above problems, the present invention adopts the following technical solutions:

A reconstituted bamboo board integrating an embossed texture decoration and protective functions, comprising a reconstituted bamboo layer and a heat-pressed and cured film layer with an embossed texture decoration located on a surface of the reconstituted bamboo layer.

As further improvement of the above technical solution:

The heat-pressed and cured film layer is formed by heat-pressing and curing a glue in glued bamboo fibers forming the reconstituted bamboo layer.

The thickness of the heat-pressed and cured film layer is between 0.05 mm and 1 mm.

The thickness of the heat-pressed and cured film layer is between 0.1 mm and 0.5 mm.

The heat-pressed and cured film layer can be a phenolic resin layer.

The heat-pressed and cured film layer can be a polyurethane layer.

In addition, the present invention also provides a manufacturing method of the reconstituted bamboo board integrating an embossed texture decoration and protection functions comprising the following steps:

S1, processing a bamboo into bamboo fibers, carrying out hydrothermal carbonization on the bamboo fibers, and then gluing and drying the carbonized bamboo fibers to obtain glued bamboo fibers;

S2, laying the glued bamboo fibers obtained in step S1 up to form a module, placing an embossed texture mold between a heat plate of a press machine and the glued bamboo fibers before heat-pressing to obtain to-be-pressed glued bamboo fibers laid up into a module; and

S3, carrying out heat-pressing and curing on the to-be-pressed glued bamboo fibers laid up into a module in step S2, wherein the glue flows and fills grain of the embossed texture mold during heat pressing and then the reconstituted bamboo board integrating an embossed texture decoration and protection functions is obtained.

As further improvement of the above technical solution:

In step S1, the glue used for gluing the bamboo fibers can be phenolic resin or polyurethane.

In step S2, the lay-up module molding is performed manually.

In step S2, the embossed texture mold is preferably made of hardened steel, and the depth of the grain is between 0.1 mm and 0.5 mm.

Compared with the prior art, the present invention has the following advantages:

This application integrates an embossed texture decoration and protective functions into a reconstituted bamboo board. A surface of a reconstituted bamboo layer is provided with a heat-pressed and cured film layer, and the heat-pressed and cured film layer has an embossed texture decoration, and non-planar different colors are formed, and thus the reconstituted bamboo board has remarkable decorative aesthetics. Moreover, compared with the existing reconstituted bamboo texture processing technology, this application can reduce material costs, simplify processing technology, reduce labor and equipment costs, and improve forming efficiency. In the meanwhile, the heat-pressed and cured film can be used as a dense protective layer, so that the reconstituted bamboo board itself has better anti-corrosion and anti-mildew weather-resistant protection functions, and no subsequent reprocessing such as planing, sanding and painting is required for outdoor applications, which is more convenient and fast. A test shows that the protection effect and durability are better than the paint effect of ordinary reconstituted bamboo boards.

Compared with the prior art where the desired texture is achieved by performing subsequent cutting and scoring, texture paint spraying or engraving with CNC machine tools again after compressing, the manufacturing method of this application is simpler; and since the texture is directly formed by an embossed texture mold and a glue during heat-pressing, the heat-pressed and cured film layer where the texture is located and the reconstituted bamboo layer are more closely connected as a whole.

### BRIEF DESCRIPTION OF THE DRAWINGS

FIG. 1 is a front-view schematic structural diagram of a reconstituted bamboo board integrating an embossed texture decoration and protective functions according to this application.

FIG. 2 is a side-view schematic structural diagram of the reconstituted bamboo board integrating embossed texture decoration and protective functions according to this application.

Reference numerals: 1. reconstituted bamboo layer; 2. heat-pressed and cured film layer.

### DESCRIPTION OF THE EMBODIMENTS

This application will be further described in detail below with reference to the accompanying drawings and embodiments of the description.

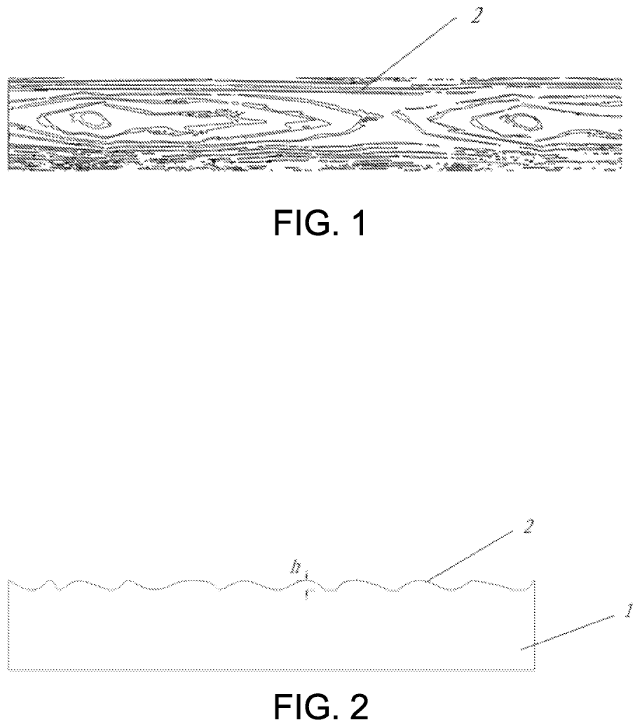

FIG. 1 to FIG. 2 show an embodiment of the reconstituted bamboo board integrating an embossed texture decoration and protective functions according to this application. The reconstituted bamboo board integrating an embossed texture decoration and protective functions of this embodiment includes a reconstituted bamboo layer 1 and a heat-pressed and cured film layer 2 with an embossed texture decoration located on a surface of the reconstituted bamboo layer 1.

In this embodiment, the heat-pressed and cured film layer 2 is formed by heat-pressing and curing a glue in glued bamboo fibers that form the reconstituted bamboo layer 1. In other words, compression molding, embossed texture modeling and weather-resistant protective layer formation of a reconstituted bamboo board are completed simultaneously. In this way, the reconstituted bamboo board is endowed with both decorative texture and anti-corrosion and anti-mildew weather resistance simultaneously. The process is completed at one time and does not require cumbersome cutting and engraving processes, thus simplifying the processing technology and reducing labor and equipment costs, and making it a reality to efficiently produce the reconstituted bamboo board with an embossed texture decoration.

Further, the thickness h of the heat-pressed and cured film layer 2 is preferably between 0.05 mm and 1 mm.

Furthermore, in this embodiment, the thickness h of the heat-pressed and cured film layer 2 is between 0.1 mm and 0.5 mm.

In this embodiment, the embossed texture is a wood texture. In other embodiments, the texture may be a marbling texture, or other embossed texture with decorative effects.

As a preferred embodiment, the heat-pressed and cured film layer 2 can be made of a glue such as phenolic resin or polyurethane by heat-pressing and curing, so that the reconstituted bamboo board itself has extremely high anti-corrosion and anti-mildew weather-resistant protection functions.

The manufacturing method of the reconstituted bamboo board integrating an embossed texture decoration and protection functions according to this application include the following steps:

S1, processing a bamboo into rolled bamboo fibers, carrying out hydrothermal carbonization on the rolled bamboo fibers, and then gluing and drying the carbonized bamboo fibers to obtain glued bamboo fibers, wherein the glue used for gluing the bamboo fibers can be phenolic resin, polyurethane, or the like;

S2, laying the gluing bamboo fibers obtained in step S1 up to form a module, placing an embossed texture mold between a heat plate of a press machine and the glued bamboo fibers before heat-pressing to obtain to-be-pressed glued bamboo fibers laid up into a module, wherein lay-up module molding can also be performed manually, the embossed texture mold is preferably made of hardened steel, the depth of grain is from 0.1 mm to 0.5 mm, and the texture can be designed in various ways according to the needs; and

S3, carrying out heat-pressing and curing on the to-be-pressed glued bamboo fibers laid up into a module in step S2, wherein the glue flows and fills the grain of the embossed texture mold during heat-pressing and then the reconstituted bamboo board integrating an embossed texture decoration and protection functions.

Compared with the prior art where the desired texture is achieved by performing subsequent cutting and scoring, texture paint spraying or engraving with CNC machine tools again after compressing, the manufacturing method of this application is simpler; and since the texture is directly formed by an embossed texture mold and a glue during heat-pressing, the heat-pressed and cured film layer 2 where the texture is located and the reconstituted bamboo layer 1 are more closely connected as a whole.

After testing, the reconstituted bamboo board integrating an embossed texture decoration and protection functions, prepared in this embodiment, can achieve a strong anti-corrosion grade I (the highest grade) and an anti-mildew grade 0 (the highest grade), which complies with the relevant national requirements and standards of China (GB/T30364-2013). In addition, the protective effect and durability of the embossed texture decoration and high weather-resistant protective layer (i.e., the heat-pressed and cured film layer 2) are better than the paint effect of ordinary products. When the thickness h of the heat-pressed and cured film layer 2 is less than 0.05 mm, the protective layer is too thin, which affects the overall anti-corrosion and anti-mildew weather resistance. When the thickness h of the heat-pressed and cured film layer 2 is greater than 1 mm, the protective layer is too thick, which leads to the reduction of the cured glue of the glued bamboo fibers. In this case, the thickness expansion rate of the product boiled in boiling water is increased from about 5% (h is 0.5 mm) to about 10% (h is 1.5 mm), which will greatly affect the product's gluing performance and the outdoor stability of products in terms of cracking, deformation and the like.

Although this application has been disclosed above with preferred embodiments, it is not intended to limit this application. Any person skilled in the art can make many possible variations and modifications to the technical solutions of this application, or amendments to the equivalent embodiments of equivalent changes by using the technical contents disclosed above without departing from the scope of the technical solutions of this application. Therefore, any simple amendments, equivalent changes and modifications made to the above embodiments according to the technical essence of this application without departing from the content of the technical solutions of this application should fall within the scope of the technical solutions of this application.

1. A reconstituted bamboo board integrating an embossed texture decoration and protective functions, comprising a reconstituted bamboo layer and a heat-pressed and cured film layer with an embossed texture decoration located on a surface of the reconstituted bamboo layer.

2. The reconstituted bamboo board integrating an embossed texture decoration and protective functions according to claim 1, wherein the heat-pressed and cured film layer is formed by heat-pressing and curing a glue in glued bamboo fibers forming the reconstituted bamboo layer.

3. The reconstituted bamboo board integrating an embossed texture decoration and protective functions according to claim 1, wherein a thickness of the heat-pressed and cured film layer is between 0.05 mm and 1 mm.

4. The reconstituted bamboo board integrating an embossed texture decoration and protective functions according to claim 3, wherein the thickness of the heat-pressed and cured film layer is between 0.1 mm and 0.5 mm.

5. The reconstituted bamboo board integrating an embossed texture decoration and protective functions according to claim 1, wherein the heat-pressed and cured film layer is a phenolic resin layer.

6. The reconstituted bamboo board integrating an embossed texture decoration and protective functions according to claim 1, wherein the heat-pressed and cured film layer is a polyurethane layer.

7. A manufacturing method of the reconstituted bamboo board integrating an embossed texture decoration and protection functions according to claim 1, comprising the following steps:
S1, processing a bamboo into bamboo fibers, carrying out hydrothermal carbonization on the bamboo fibers, and then gluing and drying the carbonized bamboo fibers to obtain glued bamboo fibers;
S2, laying the glued bamboo fibers obtained in step S1 up to form a module, placing an embossed texture mold between a heat plate of a press machine and the glued bamboo fibers before heat-pressing to obtain to-be-pressed glued bamboo fibers laid up into a module; and
S3, carrying out heat-pressing and curing on the to-be-pressed glued bamboo fibers laid up into a module in step S2, wherein a glue flows and fills grain of the embossed texture mold during heat pressing, and then the reconstituted bamboo board integrating an embossed texture decoration and protection functions is obtained.

8. The manufacturing method according to claim 7, wherein in step S1, the glue used for gluing the bamboo fibers is phenolic resin or polyurethane.

9. The manufacturing method according to claim 7, wherein in step S2, the module is performed manually.

10. The manufacturing method according to claim 7, wherein in step S2, the embossed texture mold is made of hardened steel, and a depth of the grain is between 0.1 mm and 0.5 mm.
